(19) United States
(12) Patent Application Publication
(10) Pub. No.: US 2026/0051825 A1
(43) Pub. Date: Feb. 19, 2026

(54) ELECTRICAL SYSTEM INCLUDING A CAPACITIVE PRE-CHARGE SYSTEM

(71) Applicant: Lear Corporation, Southfield, MI (US)

(72) Inventors: Michael Haggerty, Grand Blanc, MI (US); Eric Salem, Berkley, MI (US); Joseph Hornbeck, Taylor, MI (US); Sakib Shazzad, Warren, MI (US); Jatinkumar Kiritkumar Patel, Canton, MI (US)

(21) Appl. No.: 18/806,782

(22) Filed: Aug. 16, 2024

(51) Int. Cl. H02M 7/04; B60L 53/22; H02J 1/08

(52) U.S. Cl. CPC H02M 7/05; B60L 53/22; H02J 1/084; B60L 2210/30; B60L 2270/20

(57) ABSTRACT

An electrical system may include an energy store, a load, and a pre-charge system connecting the energy store and the load. The load may include a DC link. The pre-charge system may include a capacitive coupler. The pre-charge system may pre-charge the DC link of the load via a pre-charging cycle that alternates between (i) a charging phase during which the capacitive coupler and the DC link are charged by the energy store and (ii) a discharging phase during which a charge of the capacitive coupler is discharged and a charge of the DC link is maintained in the DC link.

### TECHNICAL FIELD

The present disclosure generally relates to electrical systems including a capacitive pre-charge system that may, for example, be utilized in connection with and/or incorporated in electrical vehicles (e.g., a propulsion system of an electrical vehicle). The present disclosure also generally relates to the capacitive pre-charge system of such electrical systems.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a diagram of an embodiment of an electrical system according to teachings of the present disclosure.

FIG. 2 is a diagram of an embodiment of an electrical system operating in a pre-charge mode during a first/charging phase of a pre-charging cycle according to teachings of the present disclosure.

FIG. 3 is a diagram of an embodiment of an electrical system operating in a pre-charge mode during a second/discharging phase of a pre-charging cycle according to teachings of the present disclosure.

FIG. 4 is a diagram of an embodiment of an electrical system operating in a standard mode according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

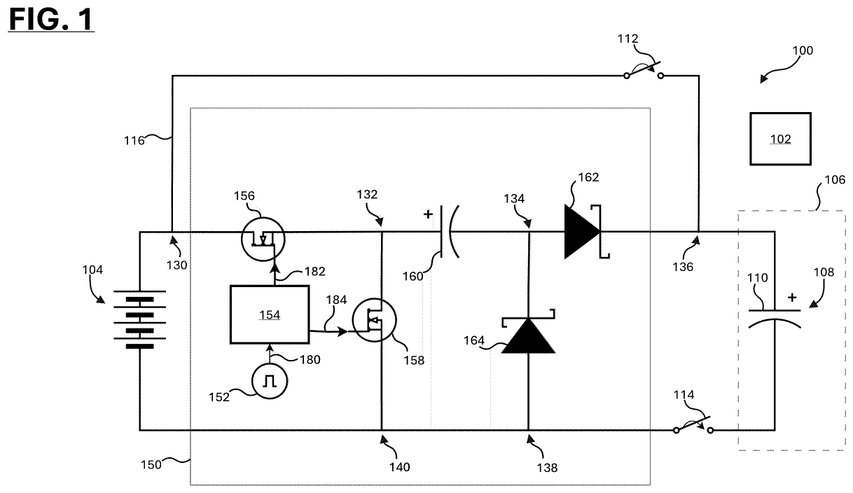

Referring to FIGS. 1-4, an electrical system 100 includes a controller 102 (e.g., an electronic control unit/ECU), at least one energy store 104 (e.g., a power source, battery, capacitor, transformer, etc.), at least one electrical load 106 (e.g., outputs, motors, actuators, etc.), one or more electrical components (e.g., switches, contactors, diodes, resistors, sensors, etc.), and a pre-charge system 150. The electrical components of the electrical system 100 includes at least a first switch 112 and a second switch 114. In at least some embodiments, the electrical system 100 may be incorporated into and/or a component of a vehicle (e.g., an electrical vehicle), the controller 102 may be part of and/or configured as a control module of the vehicle, the energy store 104 may be a battery of the vehicle, and/or the load 106 may be an AC motor of the vehicle (e.g., a large AC motor of an electric vehicle propulsion system).

The controller 102 is operatively connected (e.g., communicatively, physically, and/or wirelessly) to one or more other components of the electrical system 100 and controls, operates, and/or adjusts the electrical system 100. The controller 102 is operatively (e.g., communicatively, physically, and/or wirelessly) connected to the first switch 112, the second switch 114, the pre-charge system 150 (e.g., the pulse generator 152), and/or the load 106. The controller 102 is configured to actuate and/or adjust the first switch 112 to an open state and to a closed state (e.g., via sending a signal to the first switch 112 to open and/or close the first switch 112). The controller 102 is configured to actuate and/or adjust the second switch 114 to an open state and to a closed state (e.g., via sending a signal to the second switch 114 to open and/or close the second switch 114). The controller 102 is configured to actuate, activate, deactivate, and/or control the pulse generator 152 (e.g., via sending a signal to the pulse generator 152), such as to modify, adjust, and/or change the characteristics of the pulse signal 180 produced thereby. The controller 102 may also be configured to actuate, activate, deactivate, and/or control the load 106 (e.g., via sending a signal to the load 106).

The energy store 104 is configured to provide energy and/or electrical power to the load 106 and/or one or more other components. The energy store 104 may include one or more of a variety of shapes, sizes, configurations, and/or materials. For example and without limitation, the energy store 104 includes one or more batteries that include one or more cells. The energy store 104 is configured to provide electrical energy at a certain voltage and/or within a certain range of voltages (e.g., at or about 100 volts, 500 volts, 850 volts, 2000 volts, and/or 3000 volts). The energy store 104 includes a first terminal and a second terminal. The first terminal of the energy store 104 is connected to the first terminal of the first semiconductor switch 156 and the first terminal of the first switch 112 at the first node 130. The second terminal of the energy store 104 is connected to the sixth node 140, the fifth node 138 (e.g., via the sixth node 140), the second terminal of the second semiconductor switch 158 (e.g., at and/or via the sixth node 140), the first terminal of the second rectifier 164 (e.g., at and/or via the fifth node 138), and the second terminal of the second switch 114 (e.g., at and/or via the fifth node 138).

The first and second switches 112, 114 may include one or more of a variety of configurations and may include, for example, electrical relays, switches, and/or contactors. The switches 112, 114 are disposed electrically (e.g., in an electrical path and/or circuit) between the energy store 104 and the load 106, and are configured to selectively connect (e.g., when in the closed state) and/or disconnect (e.g., when in the open state) the energy store 104 and the load 106. The switches 112, 114 connect and/or disconnect the energy store 104 and the load 106 (e.g., transition between open and closed states) very quickly, which may be almost instantaneously. There may be and/or generally is an initial voltage difference between a voltage of the energy store 104 (e.g., an energy store voltage) and a voltage of the load 106 (e.g., a load voltage). If the difference in voltage is greater than a predetermined threshold, instantaneously connecting the energy store 104 and the load 106 may cause the load 106 to receive a large inrush current from the energy store 104, which could cause a malfunction of and/or cause damage to one or more elements and/or components of the system 100. For example, the switches 112, 114 may not be configured for large voltage differences (e.g., of at least 500 volts, 800 volts, etc.) and/or large inrush currents, and instantaneously connecting the energy store 104 and the load 106 may cause a malfunction of and/or damage the switches 112, 114 (e.g., contact welding of one or more of the switches 112, 114 in its respective closed state).

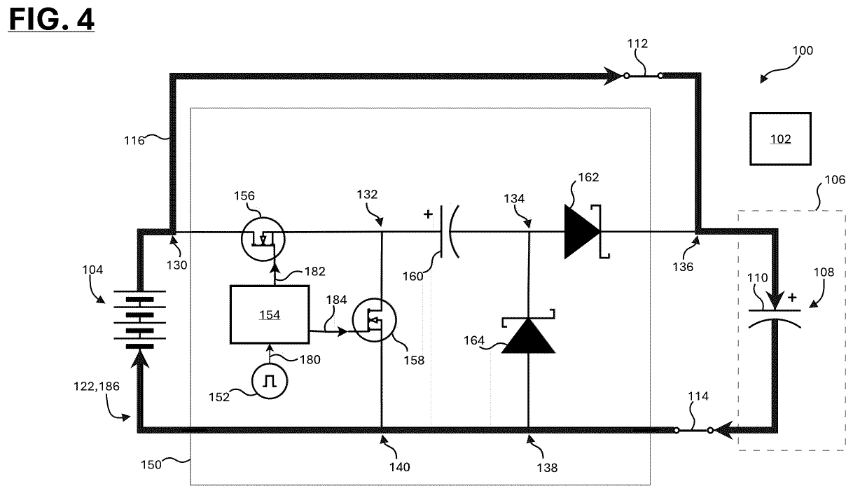

The first switch 112 is disposed in and controls the flow of electrical energy 186 through a bypass line 116, which extends from the first node 130 to the fourth node 136 and bypasses the pre-charge system 150. In this way, the first switch 112 is configured to selectively electrically connect (i) the energy store 104 and the load 106 (e.g., the DC link 108) and/or (ii) the first node 130 and the fourth node 136 via the bypass line 116. The first switch 112 includes a first terminal and a second terminal. The first terminal of the first switch 112 is connected to the first node 130, the first terminal of the energy store 104 (e.g., at and/or via the first node 130), and the first terminal of the first semiconductor switch 156 (e.g., at and/or via the first node 130). The second terminal of the first switch 112 is connected to the fourth node 136, the second terminal of the second rectifier 164 (e.g., at and/or via the fourth node 136), and the first terminal of the DC link 108 (e.g., at and/or via the fourth node 136). The first switch 112 is operatively (e.g., communicatively, physically, and/or wirelessly) connected to the controller 102 and is actuated, activated/deactivated, adjusted, and/or controlled by the controller 102. The first switch 112 is adjustable to a closed state and/or position and to an open state and/or position via the controller 102. When the first switch 112 is in the closed state (see, e.g., FIG. 4), the first terminal of the energy store 104 is electrically connected to the load 106 and/or the DC link 108 via the bypass line 116 and the electrical energy output 186 of the energy store 104 effectively bypasses the pre-charge system 150 on its way to the DC link 108 and/or the load 106 by flowing through the bypass line 116. When the first switch 112 is in the open state (see, e.g., FIGS. 1-3), the energy store 104 is not electrically connected to the load 106 and/or the DC link 108 via the bypass line 116, which forces the electrical energy 186 output by the energy store 104 to pass through the pre-charge system 150 on its way to the DC link 108 and/or the load 106 (i.e., the electrical energy 186 is blocked and/or prevented from bypassing the pre-charge system 150 via the bypass line 116).

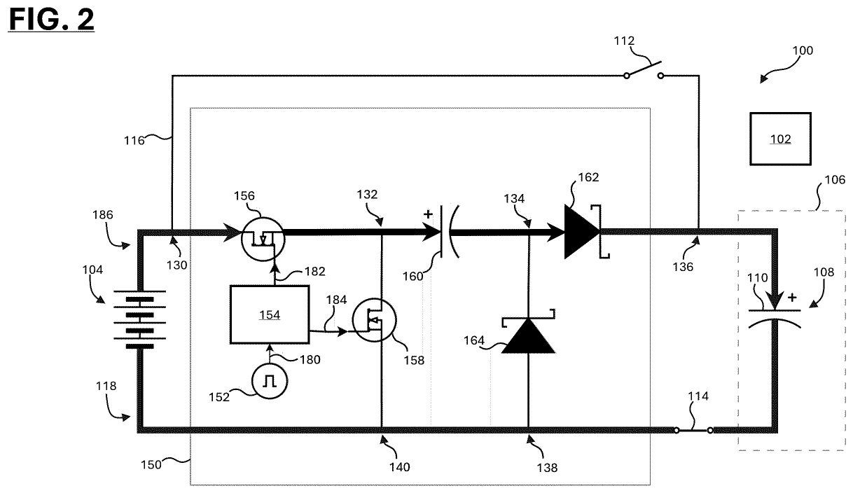

The second switch 114 is configured to selectively electrically connect the load 106 (e.g., the DC link 108) to (i) the energy store 104, (ii) the pre-charge system 150, (iii) the fifth node 138, and/or (iv) the sixth node 140. The second switch 114 may interact with a battery disconnect unit and be utilized to disconnect the energy store 104 from the load 106. The second switch 114 includes a first terminal and a second terminal. The first terminal of the second switch 114 is connected to the second terminal of the DC link 108. The second terminal of the second switch 114 is connected to the fifth node 138, the sixth node 140 (e.g., via the fifth node 138), the first terminal of the second rectifier 164 (e.g., at and/or via the fifth node 138), the second terminal of the second semiconductor switch 158 (e.g., at and/or via the sixth node 140), and the second terminal of the energy store 104 (e.g., at and/or via the sixth node 140). The second switch 114 is operatively (e.g., communicatively, physically, and/or wirelessly) connected to the controller 102 and is actuated, activated/deactivated, adjusted, and/or controlled by the controller 102. The second switch 114 is adjustable to a closed state and/or position and to an open state and/or position via the controller 102. When the second switch 114 is in the closed state (see, e.g., FIGS. 2-4), the load 106 and/or the DC link 108 is electrically connected to the energy store 104. When the second contactor is in the open state (see, e.g., FIG. 1), the load 106 and/or the DC link 108 is not electrically connected to the energy store 104.

The electrical load 106 is generally a high voltage electrical load and is typically an inverter. For example, the load 106 may be an AC motor that converts stored electrical energy into mechanical energy. While the electrical system 100 is described and illustrated herein with a single load 106 for simplicity, the electrical system 100 often includes several high voltage electrical loads and/or a series of high voltage electrical loads. The load 106 includes at least one DC link 108.

The DC link 108 includes, is structured as, and/or is defined by at least one capacitor 110, which is configured to store energy (e.g., an electrical charge). While the DC link 108 is described and illustrated herein with a single capacitor 110 for simplicity, the DC link 108 often includes, is structured as, and/or is defined by a plurality of capacitors 110 connected in parallel. The DC link 108 and/or the plurality of capacitors 110 thereof may be configured as and/or form a capacitor bank. The DC link 108 and/or the capacitor bank thereof generally improves performance of the electrical load 106, particularly when the load 106 is located farther and/or a greater distance from the energy store 104. The DC link 108 includes a first terminal and a second terminal. The first terminal of the DC link 108 is connected to the fourth node 136, the second terminal of the first rectifier 162 (e.g., at and/or via the fourth node 136), and the second terminal of the first switch 112 (e.g., at and/or via the fourth node 136). The second terminal of the DC link 108 is connected to the first terminal of the second switch 114.

The pre-charge system 150 is and/or may be considered a capacitive pre-charge system. The pre-charge system 150 is connected to the energy store 104 and the load 106. In embodiments, the energy store 104 and the load 106 are connected to one another via (i) the pre-charge system 150 and (ii) a bypass line 116 including the first switch 112. The pre-charge system 150 is configured to pre-charge the DC link 108 of the load 106 (e.g., via performance of a pre-charging cycle) to prevent an in-rush of electricity from flowing from the energy store 104 to the load 106 when the first and/or second switches 112, 114 are closed to supply electricity to the load 106, as this in-rush may contact weld the first switch 112 and/or the second switch 114 in their respective closed state. The pre-charge system 150 is able to pre-charge the DC link 108 of the load 106 with less energy loss (e.g., via power dissipation and/or heat) than conventional resistive pre-charge systems, which typically utilize a switch in series with a high-energy resistor. The pre-charge system 150 is also smaller, lighter, and more cost effective to produce than conventional resistive pre-charge systems.

The pre-charge system 150 includes a pulse generator 152, a gate driver 154, a plurality of semiconductor switches (e.g., a first semiconductor switch 156 and a second semiconductor switch 158), a capacitive coupler 160, and a plurality of rectifiers (e.g., a first rectifier 162 and a second rectifier 164).

The pulse generator 152 is configured to provide, produce, and/or generate one or more pulse signals 180 (e.g., a rectangular pulse waveform) with a variety of characteristics (e.g., frequency/pulse repetition rate, pulse width, voltage levels, delay, etc.). The pulse generator 152 is operatively (e.g., communicatively, physically, and/or wirelessly) connected to the controller 102 and is actuated, activated/deactivated, and/or controlled by the controller 102. The pulse generator 152 includes a terminal (e.g., an out-terminal) via which the pulse generator 152 outputs and/or transmits one or more pulse signals 180. The terminal of the pulse generator 152 is connected to the first terminal of the gate driver 154. The one or more pulse signals 180 of the pulse generator 152 are provided, output, and/or transmitted to the gate driver 154 via the terminal of the pulse generator 152.

The gate driver 154 is configured to accept an initial input (e.g., a low-power input), modify, convert, and/or amplify the initial input into an amplified input (e.g., a high-power/current input), and provide the amplified input to another component. The gate driver 154 is disposed between and connects (e.g., acts as an interface between) the pulse generator 152 and the semiconductor switches 156, 158. The gate driver 154 includes a first terminal (e.g., an in-terminal), a second terminal (e.g., a first out-terminal), and a third terminal (e.g., a second out-terminal). The first terminal of the gate driver 154 is connected to the terminal of the pulse generator 152. The second terminal of the gate driver 154 is connected to the third terminal of the first semiconductor switch 156. The third terminal of the gate driver 154 is connected to the third terminal of the second semiconductor switch 158. The gate driver 154 receives, via the first terminal, one or more pulse signals 180 from the pulse generator 152 as an initial input and modifies, converts, and/or amplifies the one or more pulse signals 180 into (i) a first amplified pulse signal 182 (i.e., a first amplified input) and (ii) a second amplified pulse signal 184 (i.e., a second amplified input). In some examples, the gate driver 154 receives, via the first terminal, a single pulse signal 180 from the pulse generator 152 as an initial input and modifies, converts, and/or amplifies the pulse signal 180 into (i) the first amplified pulse signal 182 and (ii) the second amplified pulse signal 184. In other examples, the gate driver 154 receives, via the first terminal, a first pulse signal from the pulse generator 152 as a first initial input and a second pulse signal from the pulse generator 152 as a second initial input, and modifies, converts, and/or amplifies (i) the first pulse signal into the first amplified pulse signal 182 and (ii) the second pulse signal into the second amplified pulse signal 184. The gate driver 154 provides, outputs, and/or transmits (i) the first amplified pulse signal 182 to the first semiconductor switch 156 via the second terminal and (ii) the second amplified pulse signal 184 to the second semiconductor switch 158 via the third terminal. The first amplified pulse signal 182 has the same characteristics as the second amplified pulse signal 184. However, the first amplified pulse signal 182 and the second amplified pulse signal 184 are out of phase with one another. The first and second amplified pulse signals 182, 184 are 180 degrees out of phase such that the semiconductor switches 156, 158 are in opposite states when the pulse generator 152 and/or the gate driver 154 are active and controlling the semiconductor switches 156, 158 (e.g., when the system 100 is operating in the pre-charge mode). In other words, since the first and second amplified pulse signals 182, 184 are 180 degrees out of phase, (i) the first semiconductor switch 156 is in and/or adjusted to the open state when the second semiconductor switch 158 is in and/or adjusted to the closed state and (ii) the first semiconductor switch 156 is in and/or adjusted to the closed state when the second semiconductor switch 158 is in and/or adjusted to the open state.

The first semiconductor switch 156 includes a first terminal, a second terminal, and a third terminal (e.g., a control terminal). The first terminal of the first semiconductor switch 156 is connected to the first node 130, the first terminal of the energy store 104 (e.g., at and/or via the first node 130), and the first terminal of the first switch 112 (e.g., at and/or via the first node 130). The second terminal of the first semiconductor switch 156 is connected to the second node 132, the first terminal of the capacitive coupler 160 (e.g., at and/or via the second node 132), and the first terminal of the second semiconductor switch 158 (e.g., at and/or via the second node 132). The third terminal of the first semiconductor switch 156 is connected to the second terminal of the gate driver 154. The first semiconductor switch 156 receives the first amplified pulse signal 182 from the gate driver 154 via the third terminal and is effectively controlled (e.g., actuated, activated/deactivated, adjusted, etc.) via the first amplified pulse signal 182 and/or one or more characteristics thereof. The first semiconductor switch 156 is adjustable to a closed state and an open state (e.g., via the first amplified pulse signal 182). When the first semiconductor switch 156 is in the closed state (see, e.g., FIG. 2), the energy store 104 is electrically connected (i) to the capacitive coupler 160 via the first semiconductor switch 156 and (ii) to the load 106 and/or the DC link 108 via the pre-charge system 150. When the first semiconductor switch 156 is in the open state (see, e.g., FIGS. 1, 3, 4), the energy store 104 is not electrically connected (i) to the capacitive coupler 160 via the first semiconductor switch 156 and (ii) to the load 106 and/or the DC link 108 via the pre-charge system 150.

The second semiconductor switch 158 includes a first terminal, a second terminal, and a third terminal (e.g., a control terminal). The first terminal of the second semiconductor switch 158 is connected to the second node 132, the first terminal of the capacitive coupler 160 (e.g., at and/or via the second node 132), and the second terminal of the first semiconductor switch 156 (e.g., at and/or via the second node 132). The second terminal of the second semiconductor switch 158 is connected to the sixth node 140, the fifth node 138 (e.g., via the sixth node 140), the second terminal of the energy store 104 (e.g., at and/or via the sixth node 140), the first terminal of the second rectifier 164 (e.g., at and/or via the fifth node 138), and the second terminal of the second switch 114 (e.g., at and/or via the fifth node 138). The second terminal of the second semiconductor switch 158 is indirectly connected to the DC link 108 and/or the load 106 at the fifth node 138 and/or the sixth node 140 via the second switch 114. The third terminal of the second semiconductor switch 158 is connected to the third terminal of the gate driver 154. The second semiconductor switch 158 receives the second amplified pulse signal 184 from the gate driver 154 via the third terminal and is effectively controlled (e.g., actuated, activated/deactivated, adjusted, etc.) via the second amplified pulse signal 184 and/or one or more characteristics thereof. The second semiconductor switch 158 is adjustable to a closed state and an open state (e.g., via the second amplified pulse signal 184). When the second semiconductor switch 158 is in the closed state (see, e.g., FIGS. 2-4), the second node 132 and the sixth node 140 are connected (e.g., electrically) via the second semiconductor switch 158. When the second semiconductor switch 158 is in the open state (see, e.g., FIG. 1), the second node 132 and the sixth node 140 are not connected (e.g., electrically) via the second semiconductor switch 158.

The capacitive coupler 160 may be configured to electrically connect several (e.g., two) portions and/or segments of a circuit. The capacitive coupler 160 includes, is structured as, and/or is defined by at least one capacitor, which is configured to store energy (e.g., an electrical charge). The capacitive coupler 160 includes a first terminal and a second terminal. The first terminal of the capacitive coupler 160 is connected to the second node 132, the first terminal of the second semiconductor switch 158 (e.g., at and/or via the second node 132), and the second terminal of the first semiconductor switch 156 (e.g., at and/or via the second node 132). The second terminal of the capacitive coupler 160 is connected to the third node 134, the first terminal of the first rectifier 162 (e.g., at and/or via the third node 134), and the second terminal of the second rectifier 164 (e.g., at and/or via the third node 134). The capacitance of the capacitive coupler 160 is significantly smaller than the capacitance of the DC link 108 and/or the capacitor 110 thereof.

The rectifiers 162, 164 are configured to provide rectification (i.e., to convert alternating current to direct current and/or to restrict electrical current flow to a single direction). In the examples depicted herein, each of the rectifiers 162, 164 is a Schottky diode, but one or more of the rectifiers 162, 164 may alternatively have one or more other suitable configurations such as semi-conductor switches with body diodes or other fast-acting rectifier technology capable of sustaining high current pulses.

The first rectifier 162 (e.g., first Schottky diode) includes a first terminal and a second terminal. The first terminal of the first rectifier 162 is connected to the third node 134, the second terminal of the capacitive coupler 160 (e.g., at and/or via the third node 134), and the second terminal of the second rectifier 164 (e.g., at and/or via the third node 134). The second terminal of the first rectifier 162 is connected to the fourth node 136, the second terminal of the first switch 112 (e.g., at and/or via the fourth node 136), and the first terminal of the DC link 108 and/or the load 106 (e.g., at and/or via the fourth node 136). Electrical energy 186 is capable of flowing through the first rectifier 162 from the third node 134 to the fourth node 136. However, due to the orientation of the first rectifier 162, the first rectifier 162 restricts, limits, blocks, and/or prevents electrical energy 186 from flowing through the first rectifier 162 from the fourth node 136 to the third node 134.

The second rectifier 164 (e.g., second Schottky diode) includes a first terminal and a second terminal. The first terminal of the second rectifier 164 is connected to the fifth node 138, the sixth node 140 (e.g., via the fifth node 138), the second terminal of the second switch 114 (e.g., at and/or via the fifth node 138), the second terminal of the second semiconductor switch 158 (e.g., at and/or via the sixth node 140), and the second terminal of the energy store 104 (e.g., at and/or via the sixth node 140). The first terminal of the second rectifier 164 is indirectly connected to the DC link 108 and/or the load 106 at the fifth node 138 via the second switch 114. The second terminal of the second rectifier 164 is connected to the third node 134, the second terminal of the capacitive coupler 160 (e.g., at and/or via the third node 134), and the first terminal of the first rectifier 162 (e.g., at and/or via the third node 134). Electrical energy 186 is capable of flowing through the second rectifier 164 from the fifth node 138 to the third node 134. However, due to the orientation of the second rectifier 164, the second rectifier 164 restricts, limits, blocks, and/or prevents electrical energy 186 from flowing from the third node 134 to the fifth node 138 through the second rectifier 164 (i.e., from the capacitive coupler 134 to the second semiconductor switch 158 through the second rectifier 164).

The electrical system 100 includes a first node 130, a second node 132, a third node 134, a fourth node 136, a fifth node 138, and a sixth node 140. The energy store 104, the first switch 112 (via the bypass line 116), and the first semiconductor switch 156 are connected to one another at the first node 130. The first semiconductor switch 156, the second semiconductor switch 158, and the capacitive coupler 160 are connected to one another at the second node 132. The capacitive coupler 160, the first rectifier 162, and the second rectifier 164 are connected to one another at the third node 134. The first rectifier 162, the first switch 112 (via the bypass line 116), and the DC link 108 of the load 106 are connected to one another at the fourth node 136. The second switch 114, the DC link 108 of the load 106 (via the second switch 114), the second rectifier 164, the second semiconductor switch 158, and the energy store 104 are connected to one another at the fifth node 138 and/or the sixth node 140. The fifth node 138 and the sixth node 140 are connected directly to one another in the illustrative example herein and, thus, may alternatively be considered a single node. The fifth node 138 and the sixth node 140 are structured as a single node in some examples (i.e., the system 100 does not include a sixth node 140).

The electrical system 100 may be initially operated in a pre-charge mode to pre-charge the DC link 108 and, once the DC link 108 has been pre-charged, the system 100 is operated in a standard mode. In the pre-charge mode, the pre-charge system 150 continually performs a pre-charging cycle that alternates between a charging phase and a discharging phase according to the characteristics (e.g., amplitude, wavelength, frequency, period) of the pulse signals 180 and/or the amplified pulse signals 182, 184. During the charging phase, the pre-charge system 150 is active, and the capacitive coupler 160 and the DC link 108 are charged simultaneously by the energy store 104. The amount of electrical energy and/or charge deposited in the DC link 108 during the charging phase is generally limited by the capacitive coupler 160. During the discharging phase, the charge deposited, accumulated, and/or stored in the capacitive coupler 160 is output, discharged, and/or dumped (e.g., essentially to a ground) while the electrical energy and/or charge deposited in the DC link 108 is stored and/or maintained in the DC link 108. This enables the capacitive coupler 160 to be charged again during the next charging phase and, thus, the DC link 108 to be further charged. The electrical energy and/or charge provided to and/or deposited in the DC link 108 during each charging phase of the pre-charging cycle is maintained and/or stored in the DC link 108 and accumulates over time. The stored electrical energy and/or charge of the DC link 108 thus gradually increases during performance of the pre-charging cycle. The pre-charging cycle is performed until the DC link 108 is fully charged and/or until the voltage difference between the voltage of the energy store 104 (e.g., the energy store voltage) and the voltage of the load 106 (e.g., the load voltage) is below the predetermined threshold. In this way, the DC link 108 is pre-charged to reduce the voltage difference between the energy store voltage and the load voltage below the predetermined threshold thereby preventing and/or reducing the risk of the load 106 receiving a large inrush current from the energy store 104. Once the DC link 108 has been pre-charged, the controller 102 adjusts the electrical system 100 from the pre-charge mode to the standard mode. When operating in the standard mode, the pre-charge system 150 is generally inactive and is bypassed by the electrical energy 186 flowing from the energy store 104 to the load 106.

An exemplary method of operating the electrical system 100, of operating the pre-charge system 150, and/or of pre-charging a DC link 108 of a load 106 is disclosed. The method may include operating the electrical system 100 in a pre-charge mode to perform a pre-charging cycle and, thus, pre-charge the DC link 108 of the load 106. The method may further include operating the electrical system 100 in the standard mode (see, e.g., FIG. 4) once the DC link 108 has been pre-charged (i.e., after operating the system 100 in the pre-charge mode).

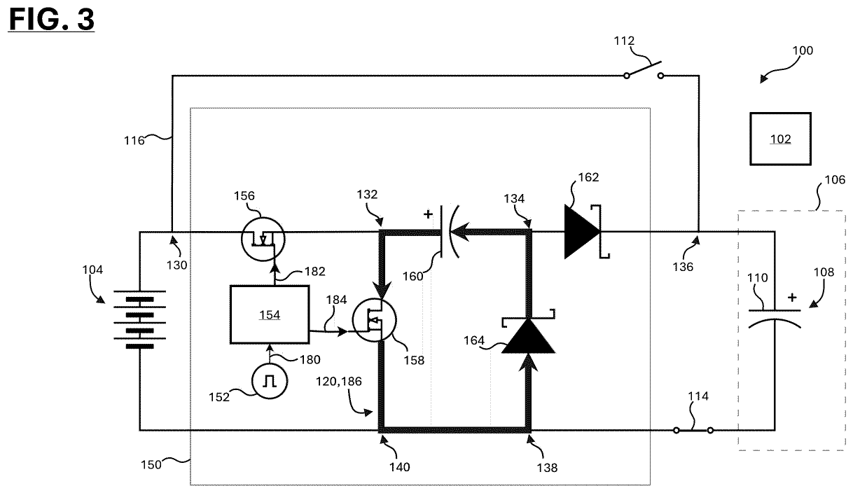

The method includes performing (e.g., with and/or using the pre-charge system 150) a pre-charging cycle that alternates between a charging phase (see, e.g., FIG. 2) and a discharging phase (see, e.g., FIG. 3) according to the characteristics of the one or more pulse signals 180, 182, 184 to pre-charge the DC link 108 of the load 106. Performance of the pre-charging cycle and/or pre-charging the DC link 108 includes reducing the voltage difference between the voltage of the energy store 104 (e.g., the energy store 104 voltage) and the voltage of the load 106 (e.g., the load 106 voltage) below the predetermined threshold thereby preventing and/or reducing the risk of the load 106 receiving a large inrush current from the energy store 104.

To operate in the pre-charge mode and/or initiate performance of the pre-charging cycle, the controller 102 (i) adjusts the first switch 112 to the open state (e.g., from the closed state) if the first switch 112 is not already in the open state, (ii) adjusts the second switch 114 to the closed state (e.g., from the open state) if the second switch 114 is not already in the closed state, (iii) activates, turns on, and/or powers up the pulse generator 152, and (iv) instructs the pulse generator 152 to provide one or more pulse signals 180 with a set of desired characteristics to the gate driver 154.

During performance of the pre-charging cycle, the pulse generator 152 provides one or more pulse signals 180 with a set of desired characteristics to the gate driver 154. The gate driver 154 receives the pulse signal(s) 180 as one or more initial inputs, modifies, converts, and/or amplifies the initial input(s) into one or more amplified inputs (e.g., amplified pulse signals 182, 184), and provides/outputs the amplified inputs to the semiconductor switches 156, 158 (e.g., the first amplified pulse signal 182 to the first semiconductor switch 156 and the second amplified pulse signal 184 to the second semiconductor switch 158). The pulse generator 152 and the gate driver 154 may continuously perform these steps, processes, and/or actions throughout performance of the pre-charging cycle (i.e., while the system 100 is operating the pre-charge mode) including during both the charging phase and the discharging phase.

During the charging phase of the pre-charging cycle, which is generally illustrated in FIG. 2, the first semiconductor switch 156 is in the closed state (e.g., due to the phase of the first amplified pulse signal 182) and the second semiconductor switch 158 is in the open state (e.g., due to the phase of the second amplified pulse signal 184, which is 180 degrees out of phase from the first amplified pulse signal 182) forming a first electrical circuit 118. The first electrical circuit 118 extends sequentially through the energy store 104, the first node 130, the first semiconductor switch 156, the second node 132, the capacitive coupler 160, the third node 134, the first rectifier 162, the fourth node 136, the DC link 108, the second switch 114, the fifth node 138, the sixth node 140, and back to the energy store 104. The energy store 104 supplies and/or outputs electrical energy 186 which flows from the energy store 104 through the first node 130, the first semiconductor switch 156, the second node 132, the capacitive coupler 160, the third node 134, the first rectifier 162, and the fourth node 136 to the DC link 108. The electrical energy 186 is deposited into the capacitive coupler 160 and into the DC link 108 thereby simultaneously charging the capacitive coupler 160 and the DC link 108 (i.e., increasing each of their stored voltage). The amount of electrical energy and/or charge provided to and/or deposited in the DC link 108 (i.e., the increase in voltage) during the charging phase is generally limited by the capacitive coupler 160 (e.g., the capacitance of the capacitive coupler 160).

Next, the pre-charging cycle transitions from the charging phase to the discharging phase (e.g., due to the pulse signals 180 and/or the amplified pulse signals 182, 184). This occurs when the phase of the first amplified pulse signal 182 transitions from a peak to a nadir of its waveform and the phase of the second amplified pulse signal 184 transitions from a nadir to a peak of its waveform, or vice versa. Additionally and/or alternatively, the pre-charging cycle transitions from the charging phase to the discharging phase when the capacitive coupler 160 has been completely or nearly completed charged (e.g., reaches or nearly reached a fully charged state) and/or charging of the DC link 108 has stopped and/or significantly slowed. In some examples, charging of the DC link 108 may be stopped and/or significantly slowed via the capacitive coupler 160 (e.g., by the capacitive coupler 160 becoming fully charged and limiting, restricting, blocking, and/or preventing the flow of electricity to the DC link 108).

During the discharging phase, which is generally illustrated in FIG. 3, the first semiconductor switch 156 is in the open state (e.g., due to the phase of the first amplified pulse signal 182) and the second semiconductor switch 158 is in the closed state (e.g., due to the phase of the second amplified pulse signal 184) forming a second electrical circuit 120. The second electrical circuit 120 extends sequentially through the capacitive coupler 160, the second node 132, the second semiconductor switch 158, the sixth node 140, the fifth node 138, the second rectifier 164, the third node 134, and back to the capacitive coupler 160. The capacitive coupler 160 outputs, discharges, and/or dumps the electrical energy and/or charge that was deposited and/or accumulated in the capacitive coupler 160 during the previous charging phase to enable the capacitive coupler 160 to be charged again during the next charging phase of the pre-charging cycle. The capacitive coupler 160 discharges its accumulated electrical energy and/or charge via supplying and/or outputting electrical energy 186 through the second electrical circuit 120. The electrical energy 186 therefore flows from the capacitive coupler 160 through the second node 132, the second semiconductor switch 158, the sixth node 140, the fifth node 138, the second rectifier 164, the third node 134, and back to the capacitive coupler 160. This flow of energy allows the charge differential that was built up across the capacitive coupler 160 to be equalized, thus removing any store of electrical potential energy on the capacitive coupler 160. The charge deposited and/or accumulated in the DC link 108 remains stationary (i.e., is not discharged and/or output) during the discharging phase. For example, the electricity and/or charge stored in the DC link 108 is limited, restricted, blocked, and/or prevented from flowing out from the DC link 108 and back through (i) the first rectifier 162 due to the orientation of the first rectifier 162 and (ii) the bypass line 116 due to the first switch 112 being in the open state.

The pre-charging cycle then transitions from the discharging phase back to the charging phase (e.g., due to the pulse signals 180 and/or the amplified pulse signals 182, 184). This occurs when the phase of the first amplified pulse signal 182 transitions from a nadir to a peak of its waveform and the phase of the second amplified pulse signal 184 transitions from a peak to a nadir of its waveform, or vice versa. Additionally and/or alternatively, the pre-charging cycle transitions from the discharging phase to the charging phase when the capacitive coupler 160 has been completely or nearly completely discharged and/or dumped its stored charge (e.g., reaches or nearly reached a fully discharged state).

The previously described steps/processes of the charging phase and the discharging phase are then repeated. Since the charge deposited and/or accumulated in the DC link 108 remains stationary during the discharging phase, the charge deposited in the DC link 108 during each charging phase is stored in the DC link 108 and accumulates over time. This results in the electrical energy, voltage, and/or charge of the DC link 108 increasing in a stepwise manner during performance of the pre-charging cycle (e.g., increases by a certain amount during each charging phase).

Performance of the pre-charging cycle continues (i.e., the previously described steps/processes are repeated) until the DC link 108 has been pre-charged. The DC link 108 may be considered to be pre-charged when the DC link 108 is fully charged and/or the voltage difference between the voltage of the energy store 104 (e.g., the energy store 104 voltage) and the voltage of the load 106 (e.g., the load 106 voltage) is below the predetermined threshold.

With the DC link 108 pre-charged, the controller 102 proceeds to adjust the electrical system 100 from the pre-charge mode to the standard mode. To do this, the controller 102 (i) deactivates, turns off, and/or powers down the pre-charge system 150 and/or the pulse generator 152 and (ii) adjusts the first switch 112 from the open state to the closed state.

When operating in the standard mode, which is generally illustrated in FIG. 4, the switches 112, 114 are both in the closed state and the semiconductor switches 156, 158 are both in the open state forming a third electrical circuit 122. The third electrical circuit 122 extends sequentially through the energy store 104, the first node 130, the bypass line 116, the first switch 112, the fourth node 136, the DC link 108, the second switch 114, the fifth node 138, the sixth node 140, and back to the energy store 104. The pre-charge system 150 is generally inactive and/or powered off when the system 100 is operating the in the standard mode and the electrical energy 186 bypasses the pre-charge system 150 as it flows from the energy store 104 to the load 106.

The disclosure includes, without limitation, the following embodiments:
1. An electrical system, comprising: an energy store; a load including a DC link; and a pre-charge system connecting the energy store and the load, the pre-charge system including a capacitive coupler; wherein the pre-charge system pre-charges the DC link of the load via a pre-charging cycle that alternates between (i) a charging phase during which the capacitive coupler and the DC link are charged by the energy store and (ii) a discharging phase during which a charge of the capacitive coupler is discharged and a charge of the DC link is maintained in the DC link.
2. The electrical system of embodiment 1, wherein an amount of electrical energy deposited in the DC link during the charging phase is limited by the capacitive coupler.
3. The electrical system according to any of the preceding embodiments, wherein: the pre-charge system includes a first semiconductor switch and a second semiconductor switch that are each adjustable to an open state and a closed state; the first semiconductor switch is in the closed state and the second semiconductor switch is in the open state during the charging phase of the pre-charging cycle; and the first semiconductor switch is in the open state and the second semiconductor switch is in the closed state during the discharging phase of the pre-charging cycle.
4. The electrical system according to any of the preceding embodiments, wherein: the pre-charge system includes (i) a gate driver connected to the first semiconductor switch and the second semiconductor switch and (ii) a pulse generator connected to the gate driver; the first semiconductor switch is adjustable to the open state and the closed state via a first amplified pulse signal provided by the gate driver; and the second semiconductor switch is adjustable to the open state and the closed state via a second amplified pulse signal provided by the gate driver.
5. The electrical system according to any of the preceding embodiments, wherein the first amplified pulse signal and the second amplified pulse signal are 180 degrees out of phase such that (i) the first semiconductor switch is in the open state when the second semiconductor switch is in the closed state and (ii) the first semiconductor switch is in the closed state when the second semiconductor switch is in the open state.
6. The electrical system according to any of the preceding embodiments, wherein, when the first semiconductor switch is in the closed state, the energy store and the capacitive coupler are electrically connected to one another via the first semiconductor switch.
7. The electrical system according to any of the preceding embodiments, wherein: the pre-charge system includes a rectifier connected to the capacitive coupler and the second semiconductor switch, the rectifier oriented to restrict electrical energy flow from the capacitive coupler to the second semiconductor switch through the second rectifier; when the second semiconductor switch is in the closed state, the rectifier and the capacitive coupler are electrically connected to one another via the second semiconductor switch; and during the discharging phase of the pre-charging cycle, electrical energy is discharged by the capacitive coupler and flows sequentially through the second semiconductor switch and the rectifier.
8. The electrical system according to any of the preceding embodiments, wherein the pre-charge system includes a rectifier via which the capacitive coupler and the DC link of the load are electrically connected.
9. The electrical system according to any of the preceding embodiments, further comprising a bypass line connecting the energy store to the load and bypassing the pre-charge system.
10. The electrical system according to any of the preceding embodiments, further comprising a switch disposed in the bypass line, wherein the switch is adjustable to a closed state and to an open state to selectively electrically connect the energy store and the load via the bypass line.
11. The electrical system according to any of the preceding embodiments, further comprising a second switch via which the load is selectively electrically connected to at least one of the pre-charge system and the energy store.
12. A pre-charge system, comprising: a pulse generator; a gate driver connected to the pulse generator; a first semiconductor switch connectable to an energy store at a first node; a second semiconductor switch; a capacitive coupler; a first rectifier; and a second rectifier; wherein the first semiconductor switch, the second semiconductor switch, and the capacitive coupler are connected to one another at a second node; wherein the capacitive coupler, the first rectifier, and the second rectifier are connected to one another at a third node; wherein the first rectifier is connectable to a DC link of a load at a fourth node; and wherein at least one of the second semiconductor switch and the second rectifier are connectable to said energy store and said DC link of said load at a fifth node and/or a sixth node.
13. The pre-charge system of embodiment 12, wherein: the first semiconductor switch is adjustable to an open state and a closed state via a first amplified pulse signal; and the second semiconductor switch is adjustable to an open state and a closed state via a second amplified pulse signal.
14. The pre-charge system according to any of the preceding embodiments, including (i) a gate driver connected to the first semiconductor switch and the second semiconductor switch and (ii) a pulse generator connected to the gate driver, wherein: the pulse generator provides at least one pulse signal to the gate driver; and the gate driver modifies the at least one pulse signal into the first amplified pulse signal and the second amplified pulse signal, provides the first amplified pulse signal to the first semiconductor switch, and provides the second amplified pulse signal to the second semiconductor switch.
15. The pre-charge system according to any of the preceding embodiments, wherein: the first amplified pulse signal and the second amplified pulse signal are 180 degrees out of phase such that (i) the first semiconductor switch is in the open state when the second semiconductor switch is in the closed state and (ii) the first semiconductor switch is in the closed state when the second semiconductor switch is in the open state; the first semiconductor switch is in the closed state and the second semiconductor switch is in the open state during a charging phase of a pre-charging cycle during which the capacitive coupler and said DC link of said load are charged by said energy store; and the first semiconductor switch is in the open state and the second semiconductor switch is in the closed state during a discharging phase of the pre-charging cycle during which a charge of the capacitive coupler is discharged and a charge of said DC link is maintained in said DC link.
16. The pre-charge system according to any of the preceding embodiments, wherein: the first rectifier is oriented to restrict electrical energy flow through the first rectifier from the fourth node to the third node; and the second rectifier is oriented to restrict electrical energy flow through the second rectifier from the third node to the at least one of the fifth node and the sixth node.
17. An electrical system, comprising: an energy store; a load including a DC link; a pre-charge system connecting the energy store and the load, the pre-charge system including: a pulse generator; a gate driver connected to the pulse generator; a first semiconductor switch connected to the gate driver; a second semiconductor switch connected to the gate driver; a capacitive coupler; a first rectifier; and a second rectifier; a first node at which the first semiconductor switch and the energy store are connected to one another; a second node at which the first semiconductor switch, the second semiconductor switch, and the capacitive coupler are connected to one another; a third node at which the capacitive coupler, the first rectifier, and the second rectifier are connected to one another; a fourth node at which the first rectifier and the DC link of the load are connected to one another; and at least one of a fifth node and a sixth node at which the energy store, the second semiconductor switch, the second rectifier, and the DC link of the load are connected to one another.
18. The electrical system of embodiment 17, further comprising a bypass line via which electrical energy is flowable from the energy store to the load to bypass the pre-charge system, wherein the bypass line is connected to the energy store at the first node and is connected to the load at the fourth node.
19. The electrical system according to any of the preceding embodiments, further comprising a first switch disposed in the bypass line, wherein the switch is adjustable to (i) a closed state where electrical energy is flowable from the energy store to the load via the bypass line and (ii) an open state where electrical energy is not flowable from the energy store to the load via the bypass line.
20. The electrical system according to any of the preceding embodiments, further comprising a second switch via which the load is selectively electrically connected to the at least one of the fifth node and the sixth node.

In examples, an electronic control unit (ECU) may include an electronic controller and/or include an electronic processor, such as a programmable microprocessor and/or microcontroller. In embodiments, an ECU may include, for example, an application specific integrated circuit (ASIC). An ECU may include a central processing unit (CPU), a memory (e.g., a non-transitory computer-readable storage medium), and/or an input/output (I/O) interface. An ECU may be configured to perform various functions, including those described in greater detail herein, with appropriate programming instructions and/or code embodied in software, hardware, and/or other medium. In embodiments, an ECU may include a plurality of controllers. In embodiments, an ECU may be connected to a display, such as a touchscreen display.

It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. An electrical system, comprising:
an energy store;
a load including a DC link; and
a pre-charge system connecting the energy store and the load, the pre-charge system including a capacitive coupler;
wherein the pre-charge system pre-charges the DC link of the load via a pre-charging cycle that alternates between (i) a charging phase during which the capacitive coupler and the DC link are charged by the energy store and (ii) a discharging phase during which a charge of the capacitive coupler is discharged and a charge of the DC link is maintained in the DC link.

2. The electrical system of claim 1, wherein an amount of electrical energy deposited in the DC link during the charging phase is limited by the capacitive coupler.

3. The electrical system of claim 1, wherein:
the pre-charge system includes a first semiconductor switch and a second semiconductor switch that are each adjustable to an open state and a closed state;
the first semiconductor switch is in the closed state and the second semiconductor switch is in the open state during the charging phase of the pre-charging cycle; and
the first semiconductor switch is in the open state and the second semiconductor switch is in the closed state during the discharging phase of the pre-charging cycle.

4. The electrical system of claim 3, wherein:
the pre-charge system includes (i) a gate driver connected to the first semiconductor switch and the second semiconductor switch and (ii) a pulse generator connected to the gate driver;
the first semiconductor switch is adjustable to the open state and the closed state via a first amplified pulse signal provided by the gate driver; and
the second semiconductor switch is adjustable to the open state and the closed state via a second amplified pulse signal provided by the gate driver.

5. The electrical system of claim 4, wherein the first amplified pulse signal and the second amplified pulse signal are 180 degrees out of phase such that (i) the first semiconductor switch is in the open state when the second semiconductor switch is in the closed state and (ii) the first semiconductor switch is in the closed state when the second semiconductor switch is in the open state.

6. The electrical system of claim 3, wherein, when the first semiconductor switch is in the closed state, the energy store and the capacitive coupler are electrically connected to one another via the first semiconductor switch.

7. The electrical system of claim 3, wherein:
the pre-charge system includes a rectifier connected to the capacitive coupler and to the second semiconductor switch, the rectifier oriented to restrict electrical energy flow from the capacitive coupler to the second semiconductor switch through the rectifier;
when the second semiconductor switch is in the closed state, the rectifier and the capacitive coupler are electrically connected to one another via the second semiconductor switch; and
during the discharging phase of the pre-charging cycle, electrical energy is discharged by the capacitive coupler and flows sequentially through the second semiconductor switch and the rectifier.

8. The electrical system of claim 3, wherein the pre-charge system includes a rectifier via which the capacitive coupler and the DC link of the load are electrically connected.

9. The electrical system of claim 1, further comprising a bypass line connecting the energy store to the load and bypassing the pre-charge system.

10. The electrical system of claim 9, further comprising a switch disposed in the bypass line, wherein the switch is adjustable to a closed state and to an open state to selectively electrically connect the energy store and the load via the bypass line.

11. The electrical system of claim 1, further comprising a second switch via which the load is selectively electrically connected to at least one of the pre-charge system and the energy store.

12. A pre-charge system, comprising:
a pulse generator;
a gate driver connected to the pulse generator;
a first semiconductor switch connectable to an energy store at a first node;
a second semiconductor switch;
a capacitive coupler;
a first rectifier; and
a second rectifier;
wherein the first semiconductor switch, the second semiconductor switch, and the capacitive coupler are connected to one another at a second node;
wherein the capacitive coupler, the first rectifier, and the second rectifier are connected to one another at a third node;
wherein the first rectifier is connectable to a DC link of a load at a fourth node; and
wherein at least one of the second semiconductor switch and the second rectifier are connectable to said energy store and said DC link of said load at a fifth node and/or a sixth node.

13. The pre-charge system of claim 12, wherein:
the first semiconductor switch is adjustable to an open state and a closed state via a first amplified pulse signal; and
the second semiconductor switch is adjustable to an open state and a closed state via a second amplified pulse signal.

14. The pre-charge system of claim 13, including (i) a gate driver connected to the first semiconductor switch and to the second semiconductor switch and (ii) a pulse generator connected to the gate driver, wherein:
the pulse generator provides at least one pulse signal to the gate driver; and
the gate driver modifies the at least one pulse signal into the first amplified pulse signal and the second amplified pulse signal, provides the first amplified pulse signal to the first semiconductor switch, and provides the second amplified pulse signal to the second semiconductor switch.

15. The pre-charge system of claim 13, wherein:
the first amplified pulse signal and the second amplified pulse signal are 180 degrees out of phase such that (i) the first semiconductor switch is in the open state when the second semiconductor switch is in the closed state and (ii) the first semiconductor switch is in the closed state when the second semiconductor switch is in the open state;
the first semiconductor switch is in the closed state and the second semiconductor switch is in the open state during a charging phase of a pre-charging cycle during which the capacitive coupler and said DC link of said load are charged by said energy store; and
the first semiconductor switch is in the open state and the second semiconductor switch is in the closed state during a discharging phase of the pre-charging cycle during which a charge of the capacitive coupler is discharged and a charge of said DC link is maintained in said DC link.

16. The pre-charge system of claim 12, wherein:
the first rectifier is oriented to restrict electrical energy flow through the first rectifier from the fourth node to the third node; and
the second rectifier is oriented to restrict electrical energy flow through the second rectifier from the third node to the at least one of the fifth node and the sixth node.

17. An electrical system, comprising:
an energy store;
a load including a DC link;
a pre-charge system connecting the energy store and the load, the pre-charge system including:
a pulse generator;
a gate driver connected to the pulse generator;
a first semiconductor switch connected to the gate driver;
a second semiconductor switch connected to the gate driver;
a capacitive coupler;
a first rectifier; and
a second rectifier;
a first node at which the first semiconductor switch and the energy store are connected to one another;
a second node at which the first semiconductor switch, the second semiconductor switch, and the capacitive coupler are connected to one another;
a third node at which the capacitive coupler, the first rectifier, and the second rectifier are connected to one another;
a fourth node at which the first rectifier and the DC link of the load are connected to one another; and
at least one of a fifth node and a sixth node at which the energy store, the second semiconductor switch, the second rectifier, and the DC link of the load are connected to one another.

18. The electrical system of claim 17, further comprising a bypass line via which electrical energy is flowable from the energy store to the load to bypass the pre-charge system, wherein the bypass line is connected to the energy store at the first node and is connected to the load at the fourth node.

19. The electrical system of claim 18, further comprising a first switch disposed in the bypass line, wherein the first switch is adjustable to (i) a closed state where electrical energy is flowable from the energy store to the load via the bypass line and (ii) an open state where electrical energy is not flowable from the energy store to the load via the bypass line.

20. The electrical system of claim 19, further comprising a second switch via which the load is selectively electrically connected to the at least one of the fifth node and the sixth node.
